(19) United States
(12) Patent Application Publication
(10) Pub. No.: US 2013/0188228 A1
(43) Pub. Date: Jul. 25, 2013

(54) SYSTEMS AND METHODS FOR HANDLING FAXES SENT FROM DIFFERENT TIME ZONES

(71) Applicant: TAI CHEUNG POON, Hong Kong (HK)

(72) Inventor: TAI CHEUNG POON, Hong Kong (HK)

(21) Appl. No.: 13/355,184

(22) Filed: Jan. 20, 2012

(51) Int. Cl. H04N 1/32

(52) U.S. Cl. 358/442

(57) ABSTRACT

A Fax system for handling faxes sent from different time zones is provided. In one embodiment, a system is provided for handling faxes includes a mobile device representing as a fax sender, wherein the mobile device includes a cell phone, PDA, or a iPad, and wherein the mobile device is located on a first time zone; a first location device included in the mobile device; a second location device included in the fax receiver; a voice connection connecting from the mobile device to POTS; a data connection connecting from the mobile device to Internet; a fax receiver, wherein the fax receiver is located on a second time zone; a voice connection connecting from the fax receiver to POTS; a data connection connecting from the fax receiver to Internet; and a fax server handling reception of faxes on behalf of the fax receiver.

### FIELD OF THE INVENTION

This invention is generally related to fax systems. Specifically, but not related to, this invention handles fax receptions from not just local but areas of different time zones.

### BACKGROUND OF THE INVENTION

Fax, often referred as facsimile that performs transmission of scanned printed material, includes both text and images, and is normally linked to a telephone number connected to a printer or other output device. Usually, the original document is scanned with a fax machine, which processes the contents (text or images) as a single fixed graphic image, converting it into a format known as bitmap. The information is then transmitted as electrical signals through the telephone system. Fax machines can be used in any offices, not matter if the underlying business has only local offices or regional offices. For businesses that only have local offices, international businesses dealing with customers and suppliers in different countries often involve faxes sent from various countries in the world. Such faxes include sales order, sales promotion, advertising, customer debit notes, etc. For business having regional offices, however, faxes are often used to communicate internally between offices. One challenge, regardless of the type of office models, is that fax communication has legal ramifications. For example, a fax order can be deemed as a sales order of certain products or services. When a faxed is made, the order can become an offer that can be acceptable to the other side as a contract. However, legally, before the order is confirmed by the receiving side, the order can be cancelled by the sender, for whatever and whoever the reasons. Therefore, the exact timing of sending and receiving faxes can be crucial from a legal context. The resulting challenge is that most fax machines or systems cannot facilitate faxes transmitted over different time zones. The exact time of the fax sender and receiver is not known from either side. There is, therefore, a need to produce fax systems that can facilitate transmission of global faxes.

### SUMMARY OF THE INVENTION

A fax system for handling faxes sent from different time zones, comprising: a mobile device representing as a fax sender, wherein the mobile device includes a mobile devices, and wherein the mobile device is located on a first time zone; a first location device included in the mobile device; a second location device included in the fax receiver; a voice connection connecting from the mobile device to plain old telephone services (POTS); a data connection connecting from the mobile device to Internet; a fax receiver, wherein the fax receiver is located on a second time zone; a voice connection connecting from the fax receiver to POTS; a data connection connecting from the fax receiver to Internet; a fax server handling reception of faxes on behalf of the fax receiver; a processor; and a memory storing instructions to cause the processor to perform a method.

According to an embodiment of the present invention, a fax system is provided. The fax system comprises a series of steps, which comprise: sending, by the fax sender, a fax to the fax receiver, wherein the fax includes a series of forwarded faxes previously sent from other users, and the fax includes complete time zone information of each of the forwarded faxes, and the fax includes information with respect to incoming time of receiving the fax from the fax server, the incoming time and the complete time zone information of each of the forwarded faxes represented in Coordinated Universal Time (UTC) format; composing an outgoing fax, as a second fax, by the fax receiver to forward the outgoing fax to the another fax receiver, wherein the outgoing fax includes the series of the forwarded faxes previously sent from the other users; sending the outgoing fax, by the fax receiver, to the another fax receiver through the fax server, wherein the outgoing fax includes only the complete time zone information of each of the forwarded faxes without including the time zone information where the outgoing fax is sent; detecting, by the fax server that receives outgoing faxes from the fax receiver, that the outgoing fax fails to include the time zone information where the outgoing fax is sent; including into the outgoing fax, by the fax server, the time zone information where the outgoing fax is sent and is represented in UTC format, wherein the incoming time is included in the outgoing fax as fax body before the outgoing fax is sent; and including into the outgoing fax, by the fax server, the time zone information of the outgoing time when the outgoing fax is sent, wherein the outgoing time is represented in UTC format and included in a fax header of the outgoing fax; and receiving, after going through the fax server, the outgoing fax by the another fax receiver, wherein the outgoing fax received by the another fax receiver includes the complete time zone information of each of the forwarded faxes and the time zone information of the outgoing time when the outgoing fax is sent.

In a separate embodiment, the fax system includes a series of forwarded faxes previously sent from other users. The faxes may include completing time zone information of each of the forwarded faxes. The fax includes information with respect to incoming time of receiving the fax from the incoming server, the incoming time and the complete time zone information of each of the forwarded faxes represented in UTC format; composing an outgoing fax, as a second fax, by the fax receiver to forward the outgoing fax to the another fax receiver, wherein the outgoing fax includes the series of the forwarded faxes previously sent from the other users; sending the outgoing fax, by the fax receiver, to the another fax receiver through a fax server, wherein the outgoing fax includes only the complete time zone information of each of the forwarded faxes without including the time zone information where the outgoing fax is sent; detecting, by the fax server that receives outgoing faxes from the fax receiver, that the outgoing fax fails to include the time zone information where the outgoing fax is sent and that the complete time zone information of each of the forwarded faxes are represented in UTC format; converting, by the fax server that receives outgoing faxes from the fax receiver, the incoming time and the complete time zone information of each of the forwarded faxes from the UTC format to a non-UTC format, in accordance with time zone of the incoming server; including into the outgoing fax, by the fax server, both the incoming time and the complete time zone information of each of the forwarded faxes in the non-UTC format.

The incoming time and the complete time zone information is crucial. They may be included in the outgoing fax as fax body before the outgoing fax is sent; including into the outgoing fax, by the fax server, the outgoing time in the outgoing fax when the outgoing fax is sent, wherein the outgoing time is represented in UTC format and included in a fax header of the outgoing fax; and receiving, after going through the fax server, the outgoing fax by the another fax receiver, wherein the outgoing fax received by the another fax receiver includes the complete time zone information of each of the forwarded faxes and the time zone information of the outgoing time when the outgoing fax is sent.

The outgoing fax may include the complete time zone information of each of the forwarded faxes without including the time zone information where the outgoing fax is sent; detecting, by the fax server that receives outgoing faxes from the fax receiver, that the outgoing fax fails to include the time zone information where the outgoing fax is sent and that the complete time zone information of each of the forwarded faxes are represented in UTC format; converting, by the fax server that receives outgoing faxes from the fax receiver, the sending time and the complete time zone information of each of the forwarded faxes from the UTC format to a non-UTC format, in accordance with time zone of the incoming server; including into the outgoing fax, by the fax server, both the incoming time and the complete time zone information of each of the forwarded faxes in the non-UTC format.

The incoming time and the complete time zone information can be included in the outgoing fax as fax body before the outgoing fax is sent. The outgoing fax received by the another fax receiver can also include the complete time zone information of each of the forwarded faxes and the time zone information of the outgoing time when the outgoing fax is sent.

The fax server that receives outgoing faxes from the fax receiver may convert the sending time and the complete time zone information of each of the forwarded faxes from the UTC format to a non-UTC format, in accordance with time zone of the incoming server; including into the outgoing fax, by the fax server, both the sending time and the complete time zone information of each of the forwarded faxes in the non-UTC format, wherein the sending time and the complete time zone information are included in the outgoing fax as fax body before the outgoing fax is sent; including into the outgoing fax, by the fax server, the outgoing time in the outgoing fax when the outgoing fax is sent, wherein the outgoing time is represented in UTC format and included in a fax header of the outgoing fax; and receiving, after going through the fax server, the outgoing fax by the another fax receiver, wherein the outgoing fax received by the another fax receiver includes the complete time zone information of each of the forwarded faxes and the time zone information of the outgoing time when the outgoing fax is sent.

### BRIEF DESCRIPTION OF THE DRAWINGS

FIG. 1 illustrates an exemplary system of fax system, in accordance with an embodiment of the present invention.

### DETAILED DESCRIPTION

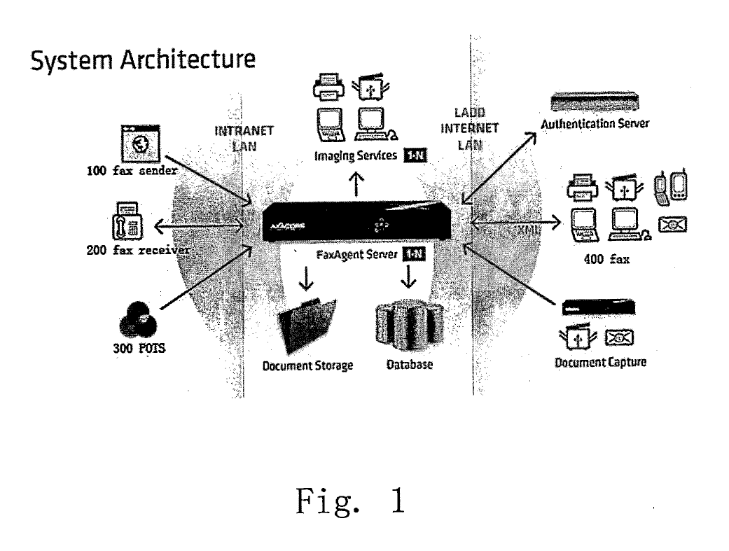

The present invention describes a fax system for handling faxes sent from different time zones. Turning to FIG. 1, an exemplary system is provided. The system comprises a mobile device representing as a fax sender, wherein the mobile device includes a cell phone, PDA, or a iPad, and wherein the mobile device is located on a first time zone; a first location device included in the mobile device; a second location device included in the fax receiver; a voice connection connecting from the mobile device to POTS; a data connection connecting from the mobile device to Internet; a fax receiver, wherein the fax receiver is located on a second time zone; a voice connection connecting from the fax receiver to POTS; a data connection connecting from the fax receiver to Internet; a fax server handling reception of faxes on behalf of the fax receiver; a processor.

The exemplary system further includes a memory storing instructions to cause the processor to perform a method, comprising sending, by the fax sender, a fax to the fax receiver, wherein the fax includes a series of forwarded faxes previously sent from other users, and the fax includes complete time zone information of each of the forwarded faxes, and the fax includes information with respect to incoming time of receiving the fax from the fax server, the incoming time and the complete time zone information of each of the forwarded faxes represented in UTC format; composing an outgoing fax, as a second fax, by the fax receiver to forward the outgoing fax to the another fax receiver, wherein the outgoing fax includes the series of the forwarded faxes previously sent from the other users; sending the outgoing fax, by the fax receiver, to the another fax receiver through the fax server, wherein the outgoing fax includes only the complete time zone information of each of the forwarded faxes without including the time zone information where the outgoing fax is sent; detecting, by the fax server that receives outgoing faxes from the fax receiver, that the outgoing fax fails to include the time zone information where the outgoing fax is sent; including into the outgoing fax, by the fax server, the time zone information where the outgoing fax is sent and is represented in UTC format.

Further in the system, the incoming time is included in the outgoing fax as fax body before the outgoing fax is sent; and including into the outgoing fax, by the fax server, the time zone information of the outgoing time when the outgoing fax is sent, wherein the outgoing time is represented in UTC format and included in a fax header of the outgoing fax; and receiving, after going through the fax server, the outgoing fax by the another fax receiver, wherein the outgoing fax received by the another fax receiver includes the complete time zone information of each of the forwarded faxes and the time zone information of the outgoing time when the outgoing fax is sent.

In a alternate system, the exemplary steps to handle the faxes sent from different time zones may include sender, wherein the mobile device includes composing an outgoing fax, as a second fax, by the fax receiver to forward the outgoing fax to the another fax receiver, wherein the outgoing fax includes the series of the forwarded faxes previously sent from the other users; sending the outgoing fax, by the fax receiver, to the another fax receiver through a fax server, wherein the outgoing fax includes only the complete time zone information of each of the forwarded faxes without including the time zone information where the outgoing fax is sent; detecting, by the fax server that receives outgoing faxes from the fax receiver, that the outgoing fax fails to include the time zone information where the outgoing fax is sent and that the complete time zone information of each of the forwarded faxes are represented in UTC format; converting, by the fax server that receives outgoing faxes from the fax receiver, the incoming time and the complete time zone information of each of the forwarded faxes from the UTC format to a non-UTC format, in accordance with time zone of the incoming server; including into the outgoing fax, by the fax server, both the incoming time and the complete time zone information of each of the forwarded faxes in the non-UTC format.

The incoming time and the complete time zone information may be included in the outgoing fax as fax body before the outgoing fax is sent; including into the outgoing fax, by the fax server, the outgoing time in the outgoing fax when the outgoing fax is sent, wherein the outgoing time is represented in UTC format and included in a fax header of the outgoing fax; and receiving, after going through the fax server, the outgoing fax by the another fax receiver, wherein the outgoing fax received by the another fax receiver includes the complete time zone information of each of the forwarded faxes and the time zone information of the outgoing time when the outgoing fax is sent.

Alternatively, the fax sender may send a fax as a first fax to the fax receiver, through a fax incoming server, wherein the fax includes a series of forwarded faxes previously sent from other users, and the fax includes complete time zone information of each of the forwarded faxes, and the fax includes information with respect to sending time when the fax is sent from the fax sender, the sending time and the complete time zone information of each of the forwarded faxes represented in UTC format; composing an outgoing fax, as a second fax, by the fax receiver to forward the outgoing fax to the another fax receiver, wherein the outgoing fax includes the series of the forwarded faxes previously sent from the other users; sending the outgoing fax, by the fax receiver, to the another fax receiver through a fax server, wherein the outgoing fax includes only the complete time zone information of each of the forwarded faxes without including the time zone information where the outgoing fax is sent; detecting, by the fax server that receives outgoing faxes from the fax receiver, that the outgoing fax fails to include the time zone information where the outgoing fax is sent and that the complete time zone information of each of the forwarded faxes are represented in UTC format; converting, by the fax server that receives outgoing faxes from the fax receiver, the sending time and the complete time zone information of each of the forwarded faxes from the UTC format to a non-UTC format, in accordance with time zone of the incoming server; including into the outgoing fax, by the fax server, both the incoming time and the complete time zone information of each of the forwarded faxes in the non-UTC format, wherein the incoming time and the complete time zone information are included in the outgoing fax as fax body before the outgoing fax is sent; including into the outgoing fax, by the fax server, the outgoing time in the outgoing fax when the outgoing fax is sent.

Further, the outgoing time may be represented in UTC format and included in a fax header of the outgoing fax; and receiving, after going through the fax server, the outgoing fax by the another fax receiver, wherein the outgoing fax received by the another fax receiver includes the complete time zone information of each of the forwarded faxes and the time zone information of the outgoing time when the outgoing fax is sent.

If desired, implementation may include sending time and the complete time zone information of each of the forwarded faxes from the UTC format to a non-UTC format, in accordance with time zone of the incoming server; including into the outgoing fax, by the fax server, both the sending time and the complete time zone information of each of the forwarded faxes in the non-UTC format, wherein the sending time and the complete time zone information are included in the outgoing fax as fax body before the outgoing fax is sent; including into the outgoing fax, by the fax server, the outgoing time in the outgoing fax when the outgoing fax is sent, wherein the outgoing time is represented in UTC format and included in a fax header of the outgoing fax; and receiving, after going through the fax server, the outgoing fax by the another fax receiver, wherein the outgoing fax received by the another fax receiver includes the complete time zone information of each of the forwarded faxes and the time zone information of the outgoing time when the outgoing fax is sent.

Further, the outgoing fax may include only the complete time zone information of each of the forwarded faxes without including the time zone information where the outgoing fax is sent; detecting, by the fax server that receives outgoing faxes from the fax receiver, that the outgoing fax fails to include the time zone information where the outgoing fax is sent and that the complete time zone information of each of the forwarded faxes are represented in UTC format; rejecting, by the fax server, the outgoing fax, after the detection by the fax server; returning, by the fax server, the outgoing fax back to the fax receiver; converting, by the fax receiver, the incoming time and the complete time zone information of each of the forwarded faxes from the UTC format to a non-UTC format, in accordance with time zone of the incoming server; including into the outgoing fax, by the fax receiver, both the incoming time and the complete time zone information of each of the forwarded faxes in the non-UTC format, wherein the incoming time and the complete time zone information are included in the outgoing fax as fax body before the outgoing fax is sent; including into the outgoing fax, by the fax receiver, the outgoing time in the outgoing fax when the outgoing fax is sent.

The sending time may then be included in the outgoing fax as fax body before the outgoing fax is sent; and including, by the fax client, the outgoing time in the outgoing fax when the outgoing fax is sent, wherein the outgoing time is represented in UTC format and included in a fax header of the outgoing fax.

The incoming time of receiving the fax may be retrieved from the incoming server, the incoming time represented in UTC format; composing an outgoing fax, wherein the outgoing fax includes the incoming fax serving as a forwarded fax; including, by the fax client, the incoming time represented in UTC format in the outgoing fax, wherein the incoming time is included in the outgoing fax as fax header before the outgoing fax is sent; and including, by the fax client, outgoing time when the outgoing fax is sent, wherein the outgoing time is represented in UTC format and included in a fax header of the outgoing fax.

In accordance with time zone of the incoming server, the fax client may include both the incoming time in the non-UTC format and information concerning time zone of the incoming server, wherein the incoming time is included in the outgoing fax as fax header before the outgoing fax is sent; and including, by the fax client, the outgoing time in the outgoing fax when the outgoing fax is sent, wherein the outgoing time is represented in UTC format and included in a fax header of the outgoing fax.

The sending time may be included in the outgoing fax as fax header before the outgoing fax is sent; and including, by the fax client, the outgoing time in the outgoing fax when the outgoing fax is sent, wherein the outgoing time is represented in UTC format and included in a fax header of the outgoing fax.

The fax may include information with respect to sending time when the fax is sent from a sender, the sending time represented in UTC format; composing an outgoing fax after receiving the incoming fax, wherein the outgoing fax includes the incoming fax serving as a forwarded fax; converting, by the fax client, the sending time from the UTC format to a non-UTC format, in accordance with time zone of the incoming server; including, by the fax client, both the sending time in the non-UTC format and information concerning the time zone of the incoming server into the outgoing fax. The sending time may be included in the outgoing fax as fax header before the outgoing fax is sent; and including, by the fax client, the outgoing time in the outgoing fax when the outgoing fax is sent, wherein the outgoing time is represented in UTC format and included in a fax header of the outgoing fax. The outgoing time may be represented in UTC format and included in a fax header of the outgoing fax.

What is claimed is:

1. A fax system for handling faxes sent from different time zones, comprising:
a mobile device representing as a fax sender, wherein the mobile device includes a cell phone, PDA, or an iPad, and wherein the mobile device is located on a first time zone;
a first location device included in the mobile device;
a second location device included in the fax receiver;
a voice connection connecting from the mobile device to POTS;
a data connection connecting from the mobile device to Internet;
a fax receiver, wherein the fax receiver is located on a second time zone;
a voice connection connecting from the fax receiver to POTS;
a data connection connecting from the fax receiver to Internet;
a fax server handling reception of faxes on behalf of the fax receiver;
a processor; and
a memory storing instructions to cause the processor to perform a method.

2. The fax system of claim 1, the method comprising:
sending, by the fax sender, a fax, as a first fax, to the fax receiver, through a fax incoming server, wherein the fax includes a series of forwarded faxes previously sent from other users, and the fax includes complete time zone information of each of the forwarded faxes, and the fax includes information with respect to incoming time of receiving the fax from the incoming server, the incoming time and the complete time zone information of each of the forwarded faxes represented in UTC format;
composing an outgoing fax, as a second fax, by the fax receiver to forward the outgoing fax to the another fax receiver, wherein the outgoing fax includes the series of the forwarded faxes previously sent from the other users;
sending the outgoing fax, by the fax receiver, to the another fax receiver through a fax server, wherein the outgoing fax includes only the complete time zone information of each of the forwarded faxes without including the time zone information where the outgoing fax is sent;
detecting, by the fax server that receives outgoing faxes from the fax receiver, that the outgoing fax fails to include the time zone information where the outgoing fax is sent and that the complete time zone information of each of the forwarded faxes are represented in UTC format;
converting, by the fax server that receives outgoing faxes from the fax receiver, the incoming time and the complete time zone information of each of the forwarded faxes from the UTC format to a non-UTC format, in accordance with time zone of the incoming server;
including into the outgoing fax, by the fax server, both the incoming time and the complete time zone information of each of the forwarded faxes in the non-UTC format, wherein the incoming time and the complete time zone information are included in the outgoing fax as fax body before the outgoing fax is sent;
including into the outgoing fax, by the fax server, the outgoing time in the outgoing fax when the outgoing fax is sent, wherein the outgoing time is represented in UTC format and included in a fax header of the outgoing fax; and
receiving, after going through the fax server, the outgoing fax by the another fax receiver, wherein the outgoing fax received by the another fax receiver includes the complete time zone information of each of the forwarded faxes and the time zone information of the outgoing time when the outgoing fax is sent.

3. The fax system of claim 1, the method comprising:
sending, by the fax sender, a fax, as a first fax, to the fax receiver, through a fax incoming server, wherein the fax includes a series of forwarded faxes previously sent from other users, and the fax includes complete time zone information of each of the forwarded faxes, and the fax includes information with respect to sending time when the fax is sent from the fax sender, the sending time and the complete time zone information of each of the forwarded faxes represented in UTC format;
composing an outgoing fax, as a second fax, by the fax receiver to forward the outgoing fax to the another fax receiver, wherein the outgoing fax includes the series of the forwarded faxes previously sent from the other users;
sending the outgoing fax, by the fax receiver, to the another fax receiver through a fax server, wherein the outgoing fax includes only the complete time zone information of each of the forwarded faxes without including the time zone information where the outgoing fax is sent;
detecting, by the fax server that receives outgoing faxes from the fax receiver, that the outgoing fax fails to include the time zone information where the outgoing fax is sent and that the complete time zone information of each of the forwarded faxes are represented in UTC format;
converting, by the fax server that receives outgoing faxes from the fax receiver, the sending time and the complete time zone information of each of the forwarded faxes from the UTC format to a non-UTC format, in accordance with time zone of the incoming server;
including into the outgoing fax, by the fax server, both the incoming time and the complete time zone information of each of the forwarded faxes in the non-UTC format, wherein the incoming time and the complete time zone information are included in the outgoing fax as fax body before the outgoing fax is sent;
including into the outgoing fax, by the fax server, the outgoing time in the outgoing fax when the outgoing fax is sent, wherein the outgoing time is represented in UTC format and included in a fax header of the outgoing fax; and
receiving, after going through the fax server, the outgoing fax by the another fax receiver, wherein the outgoing fax received by the another fax receiver includes the complete time zone information of each of the forwarded faxes and the time zone information of the outgoing time when the outgoing fax is sent.

4. The fax system of claim 1, the method comprising:
sending, by the fax sender, a fax, as a first fax, to the fax receiver, through a fax incoming server, wherein the fax includes a series of forwarded faxes previously sent from other users, and the fax includes complete time zone information of each of the forwarded faxes, and the fax includes information with respect to sending time when the fax is sent from a sender, the sending time and the complete time zone information of each of the forwarded faxes represented in UTC format;
composing an outgoing fax, as a second fax, by the fax receiver to forward the outgoing fax to the another fax receiver, wherein the outgoing fax includes the series of the forwarded faxes previously sent from the other users;
sending the outgoing fax, by the fax receiver, to the another fax receiver through a fax server, wherein the outgoing fax includes only the complete time zone information of each of the forwarded faxes without including the time zone information where the outgoing fax is sent;
detecting, by the fax server that receives outgoing faxes from the fax receiver, that the outgoing fax fails to include the time zone information where the outgoing fax is sent and that the complete time zone information of each of the forwarded faxes are represented in UTC format;
converting, by the fax server that receives outgoing faxes from the fax receiver, the sending time and the complete time zone information of each of the forwarded faxes from the UTC format to a non-UTC format, in accordance with time zone of the incoming server;
including into the outgoing fax, by the fax server, both the sending time and the complete time zone information of each of the forwarded faxes in the non-UTC format, wherein the sending time and the complete time zone information are included in the outgoing fax as fax body before the outgoing fax is sent;
including into the outgoing fax, by the fax server, the outgoing time in the outgoing fax when the outgoing fax is sent, wherein the outgoing time is represented in UTC format and included in a fax header of the outgoing fax; and
receiving, after going through the fax server, the outgoing fax by the another fax receiver, wherein the outgoing fax received by the another fax receiver includes the complete time zone information of each of the forwarded faxes and the time zone information of the outgoing time when the outgoing fax is sent.

5. The fax system of claim 1, the method comprising:
sending, by the fax sender, a fax, as a first fax, to the fax receiver, through a fax incoming server, wherein the fax includes a series of forwarded faxes previously sent from other users, and the fax includes complete time zone information of each of the forwarded faxes, and the fax includes information with respect to incoming time of receiving the fax from the incoming server, the incoming time and the complete time zone information of each of the forwarded faxes represented in UTC format;
composing an outgoing fax, as a second fax, by the fax receiver to forward the outgoing fax to the another fax receiver, wherein the outgoing fax includes the series of the forwarded faxes previously sent from the other users;
sending the outgoing fax, by the fax receiver, to the another fax receiver through a fax server, wherein the outgoing fax includes only the complete time zone information of each of the forwarded faxes without including the time zone information where the outgoing fax is sent;
detecting, by the fax server that receives outgoing faxes from the fax receiver, that the outgoing fax fails to include the time zone information where the outgoing fax is sent and that the complete time zone information of each of the forwarded faxes are represented in UTC format;
rejecting, by the fax server, the outgoing fax, after the detection by the fax server;
returning, by the fax server, the outgoing fax back to the fax receiver;
converting, by the fax receiver, the incoming time and the complete time zone information of each of the forwarded faxes from the UTC format to a non-UTC format, in accordance with time zone of the incoming server;
including into the outgoing fax, by the fax receiver, both the incoming time and the complete time zone information of each of the forwarded faxes in the non-UTC format, wherein the incoming time and the complete time zone information are included in the outgoing fax as fax body before the outgoing fax is sent;
including into the outgoing fax, by the fax receiver, the outgoing time in the outgoing fax when the outgoing fax is sent, wherein the outgoing time is represented in UTC format and included in a fax header of the outgoing fax;
resending the outgoing fax by the fax receiver to the fax server; and
receiving, after going through the fax server and the fax server, the outgoing fax by the another fax receiver, wherein the outgoing fax received by the another fax receiver includes the complete time zone information of each of the forwarded faxes and the time zone information of the outgoing time when the outgoing fax is sent.

6. The fax system of claim 1, the method comprising:
receiving, by a fax client serving as part of the electronic messaging system, an incoming fax from a fax incoming server, wherein the fax includes information with respect to sending time when the fax is sent from a sender, the sending time represented in UTC format;
composing an outgoing fax after receiving the incoming fax, wherein the outgoing fax includes the incoming fax serving as a forwarded fax;
including, by the fax client, both the sending time in the UTC format and information concerning the time zone of the sender into the outgoing fax, wherein the sending time is included in the outgoing fax as fax body before the outgoing fax is sent; and
including, by the fax client, the outgoing time in the outgoing fax when the outgoing fax is sent, wherein the outgoing time is represented in UTC format and included in a fax header of the outgoing fax.

7. The fax system of claim 1, the method comprising:
receiving, by a fax client serving as part of the electronic messaging system, an incoming fax from a fax incoming server, wherein the fax includes information with respect to incoming time of receiving the fax from the incoming server, the incoming time represented in UTC format;
composing an outgoing fax, wherein the outgoing fax includes the incoming fax serving as a forwarded fax;
including, by the fax client, the incoming time represented in UTC format in the outgoing fax, wherein the incoming time is included in the outgoing fax as fax header before the outgoing fax is sent; and
including, by the fax client, outgoing time when the outgoing fax is sent, wherein the outgoing time is represented in UTC format and included in a fax header of the outgoing fax.

8. The fax system of claim 1, the method comprising:
receiving, by a fax client serving as part of the electronic messaging system, an incoming fax from a fax incoming server, wherein the fax includes information with respect to incoming time of receiving the fax from the incoming server, the incoming time represented in UTC format;
composing an outgoing fax, wherein the outgoing fax includes the incoming fax serving as a forwarded fax;
converting, by the fax client, the incoming time from the UTC format to a non-UTC format, in accordance with time zone of the incoming server;
including, by the fax client, both the incoming time in the non-UTC format and information concerning time zone of the incoming server, wherein the incoming time is included in the outgoing fax as fax header before the outgoing fax is sent; and
including, by the fax client, the outgoing time in the outgoing fax when the outgoing fax is sent, wherein the outgoing time is represented in UTC format and included in a fax header of the outgoing fax.

9. The fax system of claim 1, the method comprising:
receiving, by a fax client serving as part of the electronic messaging system, an incoming fax from a fax incoming server, wherein the fax includes information with respect to sending time when the fax is sent from a sender, the sending time represented in UTC format;
composing an outgoing fax after receiving the incoming fax, wherein the outgoing fax includes the incoming fax serving as a forwarded fax;
converting, by the fax client, the sending time from the UTC format to a non-UTC format, in accordance with time zone of the sender;
including, by the fax client, both the sending time in the non-UTC format and information concerning the time zone of the sender into the outgoing fax, wherein the sending time is included in the outgoing fax as fax header before the outgoing fax is sent; and
including, by the fax client, the outgoing time in the outgoing fax when the outgoing fax is sent, wherein the outgoing time is represented in UTC format and included in a fax header of the outgoing fax.

10. The fax system of claim 1, the method comprising:
receiving, by a fax client serving as part of the electronic messaging system, an incoming fax from a fax incoming server, wherein the fax includes information with respect to sending time when the fax is sent from a sender, the sending time represented in UTC format;
composing an outgoing fax after receiving the incoming fax, wherein the outgoing fax includes the incoming fax serving as a forwarded fax;
converting, by the fax client, the sending time from the UTC format to a non-UTC format, in accordance with time zone of the incoming server;
including, by the fax client, both the sending time in the non-UTC format and information concerning the time zone of the incoming server into the outgoing fax, wherein the sending time is included in the outgoing fax as fax header before the outgoing fax is sent; and
including, by the fax client, the outgoing time in the outgoing fax when the outgoing fax is sent, wherein the outgoing time is represented in UTC format and included in a fax header of the outgoing fax.

11. The fax system of claim 1, the method comprising:
receiving, by a fax client serving as part of the electronic messaging system, an incoming fax from a fax incoming server, wherein the fax includes information with respect to sending time when the fax is sent from a sender, the sending time represented in UTC format;
composing an outgoing fax after receiving the incoming fax, wherein the outgoing fax includes the incoming fax serving as a forwarded fax;
converting, by the fax client, the sending time from the UTC format to a non-UTC format, in accordance with time zone of the incoming server;
including, by the fax client, only the sending time in the non-UTC format without including information concerning the time zone of the incoming server into the outgoing fax, wherein the sending time is included in the outgoing fax as fax header before the outgoing fax is sent; and
including, by the fax client, the outgoing time in the outgoing fax when the outgoing fax is sent, wherein the outgoing time is represented in UTC format and included in a fax header of the outgoing fax.

12. The fax system of claim 1, the method comprising:
receiving, by a fax client serving as part of the electronic messaging system, an incoming fax from a fax incoming server, wherein the fax includes information with respect to sending time when the fax is sent from a sender, the sending time represented in UTC format;
composing an outgoing fax after receiving the incoming fax, wherein the outgoing fax includes the incoming fax serving as a forwarded fax;
including, by the fax client, both the sending time in the UTC format and information concerning the time zone of the sender into the outgoing fax, wherein the sending time is included in the outgoing fax as fax header before the outgoing fax is sent; and
including, by the fax client, the outgoing time in the outgoing fax when the outgoing fax is sent, wherein the outgoing time is represented in UTC format and included in a fax header of the outgoing fax.
